(19) United States
(12) Patent Application Publication
(10) Pub. No.: US 2003/0159012 A1
(43) Pub. Date: Aug. 21, 2003

(54) Back-up system

(75) Inventors: Tomoaki Hirakata, Machida-shi (JP); Norifumi Takido, Machida-shi (JP); Kazuhiro Fujita, Hikone-shi (JP)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: YEC Co., Ltd., Tokyo (JP)

(21) Appl. No.: 10/368,203

(22) Filed: Feb. 18, 2003

(30) Foreign Application Priority Data
Feb. 18, 2002 (JP) 2002-040754

(51) Int. Cl. G06F 12/16; G06F 12/00

(52) U.S. Cl. 711/162; 711/156

(57) ABSTRACT

A data back up apparatus which has a control portion 3, that is connected to a cable 23 being connected to a mother board of a computer system, a cable 24 being connected to a hard disk drive of the computer system, and a cable 5 being connected to a hard disk drive provided in the data back up apparatus, respectively; the control portion 3 always keeps the connection between the mother board and the hard disk drive provided in the data back up apparatus in off, and has a semiconductor switch 34 which switches the connection of the hard disk drive of the computer between the mother board and the hard disk drive provided in the data back up apparatus; the control portion 3 controls the data back up operation and the data restoring operation and the switching operation of the switch 34.

### BACKGROUND OF THE INVENTION

1. Field of the Invention

The present invention relates to a back-up system for use in a hard disk drive of computer systems.

2. Related Art

Personal computers have a construction such that peripheral devices, such as a hard disk drive, are connected to a motherboard, on which a CPU (central processing unit) is mounted, by means of BUS lines. In a hard disk drive, operation systems or programs which are for operating the central processing unit according to the purpose of use, and in addition many kinds of data are stored there.

Such programs or data are normally backed up in order to avoid that the data or programs in the hard disks are lost by an accident error or computer viruses. The backing-up operation is normally carried out by manually copying the data or the programs into another data recording medium. In addition, another back-up system is suggested where the data or programs are automatically copied into an expanded hard disk.

However, in order to bring the back-up data into the other data recording medium, the data is logically collected (for each file) and then copied, which is a so-called “file copy”. In this method, it takes a long time for the copying operation. Since hard disk drives having a high capacity storage are recently developed, it is not preferred to back the data or the programs up by the, “file copy” method mentioned above, because it takes a longer time.

Further, in computer systems that are used by non-designated people, when some problem occurs in the computer system, it is difficult to find who and which operation caused the problem. Particularly, in case that the operator does not have sufficient knowledge about computer systems, the data is sometimes destroyed because the operator does not operate the system properly. Furthermore, operation systems or application programs recently have a large capacity and the structure of the software becomes very complicated. Therefore, even only a small part of the data stored in the hard disk drive is destroyed, for example, when a part of the software is destroyed by a computer virus or the fact that the operator does not operate the system properly, or when a new software cannot be properly installed so that a part of the former data has been rewritten, it is actually impossible to detect the destroyed part or the rewritten part to repair them.

In such a case, it is most effective to restore the backed-up data. However, in a recently developed hard disk drive having a large capacity as mentioned above, there is a drawback in that it takes a long time to restore the data.

On the other hand, in the system that a back-up data is stored in a hard disk drive apparatus, the recording time for backing up or restoring is shorter in comparison to a case where the back-up data is stored in a different data recording medium, because the back-up data is recorded in the same type of recording medium. However, in a conventional back-up system, It is constructed such that the hard disk drive apparatus for backing up is controlled by the main computer. Therefore, there still remain possibilities that the back-up data may be destroyed by the operation from the main computer system. It is, considered for instance that a computer virus could destroy the back-up data or that the back-up data also could be destroyed as well, by the fact that the operator does not operate the main computer in a proper manner.

### SUMMARY OF THE INVENTION

The present invention has its purpose to provide a back up system where back up operation of data can be carried out speedy and easily, and the back up data is not damaged by, for instance, computer viruses.

In order to carry out this purpose;

(1) The back up system according to the present invention comprises:

a switching means being connected to a first memory, a second memory, and a central processing unit for controlling said second memory, for switching a state of the data back up system between a communicable state that a communication between said first memory and said second memory is disable keeping a condition that a communication between said central processing unit and said first memory is disable, but said central processing unit and said second memory can communicate together, and a copiable condition that a communication between said central processing unit and said second memory is disable but said first memory and said second memory can communicate together;

a switching operation control means for controlling said switching means between said communicable state and said copiable state; and

a copying operation control means for controlling a copying operation from said second memory to said first memory or from said first memory to said second memory under said copiable state.

(2) The back up system according to the present invention has another aspect in that the data back up system comprises a switching means having a first connecting portion for being connected to a first memory, a second connecting portion for being connected to a second memory, and a third connecting portion for being connected to a central processing unit, for switching a state of the data back up system between a communicable state that a communication between said first memory and said second memory is disabled keeping a condition in that a communication between said central processing unit and said first memory is disabled, but said central processing unit and said second memory can communicate together, and a copiable condition that a communication between said central processing unit and said second memory is disable but said first memory and said second memory can communicate together under a condition that said first memory, said second memory, and said central processing unit are connected together,

a switching operation control means for controlling said switching means between said communicable state and said copiable state; and

a copying operation control means for controlling a copying operation from said second memory to said first memory or from said first memory to said second memory under said copiable state.

(3) It is preferred that said switching means is a semiconductor switch.

(4) It is also preferred that said first memory is a hard disk drive.

(5) It is further preferred that said second memory is a hard disk drive.

(6) It is further preferred that said data back up system further comprise a switching operation selecting means for selecting whether a copying operation of data to be recorded is conducted or not; and wherein said switching operation control means controls the switching means in accordance with the selection conducted in said switching operation selecting means.

(7) It is also preferred that the data back up state further comprises a housing for containing said data back up system itself, wherein said housing comprises a fixing portion for detachably fixing the housing itself to a case in which said central processing unit is contained.

### BRIEF DESCRIPTION OF THE DRAWINGS

FIG. 1 is a block diagram showing a construction of the personal computer system to which the back up apparatus according to the invention is connected, and a construction of the back up apparatus;

FIG. 2 is a block diagram showing a construction of the controlling portion of the back up system according to the invention;

FIG. 3 is a flow chart depicting an operation of the central processing means of the back up system according to the invention;

FIG. 4 is a flow chart illustrating an operation of the PLD of the back up system according to the invention;

FIG. 5 is a perspective view showing a state that the back up apparatus according to the invention is stored in a personal computer system;

FIG. 6 is a block diagram depicting a construction of a personal computer where the second embodiment of the invention is applied; and

FIG. 7 is a block diagram illustrating a construction of the controller in the second embodiment.

### DETAILED EXPLANATION OF THE PREFERRED EMBODIMENTS

Preferred embodiments of the present invention will be explained based on the attached drawings.

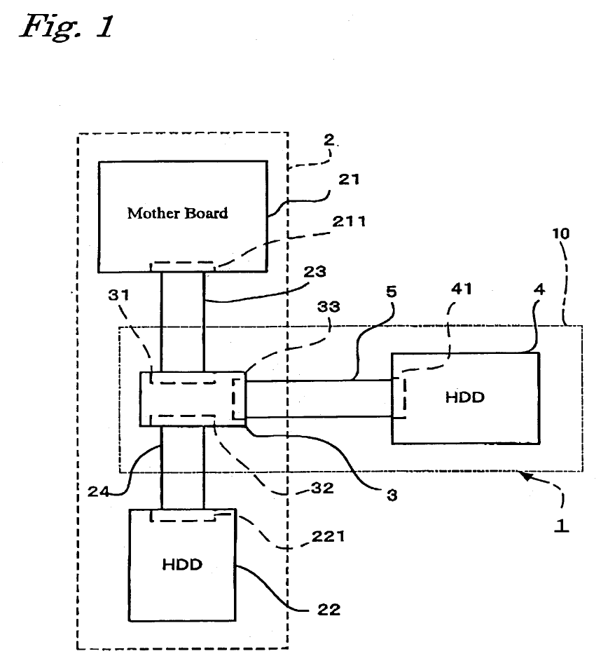

FIG. 1 is a block diagram showing a construction of a personal computer system 2 to which the back up apparatus 1 according to the invention is connected, and also showing a construction of the back up apparatus 1.

The personal computer 2 comprises a motherboard 21 on which a central processing unit (CPU) is mounted, and a hard disk drive apparatus 22 that is used as a second memory. To the input/output port 211 of the mother board 21, a flat cable 23, which constitutes a bus line of a connecting circuit for connecting the hard disk drive apparatus 22 and the central processing unit of the mother board 21. Further, to the input/output port 221 of the hard disk drive apparatus 22, a flat cable 24, which constitutes a bus line of the connecting circuit for connecting the hard disk drive apparatus 22 and the central processing unit of the mother board 21. The other ends of the flat cables 23 and 24 are connected to input/output ports 31 and 32 of the back up apparatus 1 of the present invention, respectively.

The back up apparatus 1 comprises a controlling portion 3 and a hard disk drive apparatus 4 that is used as a first memory for a back up purpose. The controlling portion 3 and the hard disk drive apparatus 4 for a back up purpose are connected together by means of a flat cable 5. As shown in FIG. 1, the controlling portion 3 comprises three input/output ports 31, 32 and 33; the input/output port 31 works as a third connecting portion which is connected to the mother board 21; the input/output port 32 works as a second connecting portion, which is connected to the hard disk drive apparatus 22; and the input/output port 33 works as a first connecting portion, which is connected to the hard disk drive apparatus 4. One of the ends of the flat cable 5 is connected to an input/output port 33 of the controlling portion 3; the other end of the flat cable 5 is connected to an input/output port 41 of the hard disk drive apparatus 4 for a back up purpose.

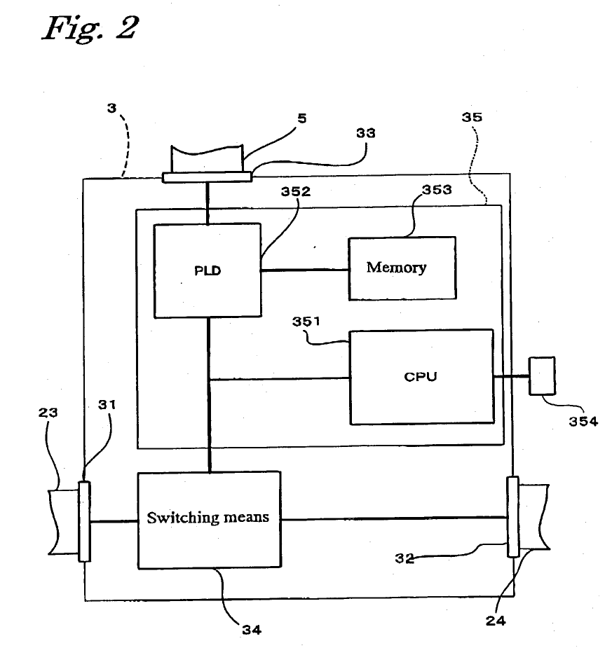

As shown in FIG. 2, the control portion 3 comprises a switching means 34 and a control unit 35. The control unit 35 comprises a central processing means 351, a secondary processing means 352, and a memory 353. The central processing means 351 (CPU) supplies command signals to said switching means 34 and the secondary processing means 352. The secondary processing means 352 carries out a mirror copy of data between the hard disk drive apparatus 22 and the hard disk drive apparatus 4 for back up propose in accordance with the command signal from the central processing means 351. The memory 353 is used for temporarily storing the data from the copy source during the operation of the data copying.

The switching means 34 constantly keeps the condition that the motherboard 21 and the hard disk drive apparatus 4 for a back up purpose cannot communicate together. Further, the switching means 34 has a function to change the connecting circuit between a copiable state and a communicable state in accordance with the command from the central processing unit 351. The copiable state means that the communication between the mother board 21 and the hard disk dive apparatus 22 is disabled and communication between the hard disk drive apparatus 22 and the hard disk drive apparatus 4 for a back up purpose is available; the communicable state means that the communication between the hard disk drive apparatus 22 and the hard disk drive apparatus 4 for a back up purpose is disabled and the communication between the mother board 21 and the hard disk drive apparatus 22 is available. In this specification, the term “communication” means sending and receiving signals, which includes the condition that an electric conductive state is kept: that is to say, “non-communicable condition” means that no signal is sent or received, while “communicable condition” means that signals can be sent or received. Therefore, the non-communicable condition includes a condition that the circuit is not electrically conducted.

Under the copiable state, the signal from the motherboard 21 is not transferred to the hard disk drive apparatus 22, and the signal from the hard disk drive apparatus 22 is not transferred to the motherboard 21. Further, in any case, the signal from the motherboard 21 is never transferred to the hard disk drive apparatus 4 for a back up purpose.

In the present embodiment, a semiconductor switch, i.e. a switch for switching the communicating circuit by means of a logical circuit, is used for the switching means that has the above-mentioned function. This switch has a sufficiently short delay time between the input and output so that the delay time does not influence the operating speed of the personal computer. Such a semiconductor switch changes the condition between the communicable state and the copiable state when receiving the switching command from the central processing unit 351.

The secondary processing means 352 operates in accordance with a copying command signal from the central processing unit 351. There are two ways for copying: one is a back up copy where data is copied from the hard disk drive apparatus 22 to the hard disk drive apparatus 4 for a back up purpose; the other one is the restoring copy where data is copied from the hard disk drive apparatus 4 for a back up purpose to the hard disk drive apparatus 22. In this embodiment, a PLD (Programmable Logic Array Device) is used for the secondary processing means 352. By using a PLD where the circuits are preliminarily designed only for copying operation, the operating speed becomes fast; then it is possible to make the copying time of the back up system 1 as a whole short. Other control circuits may also be used for the secondary processing means 352.

The power source for driving the back up apparatus 1 is available from the personal computer 2 that is connected thereto. Therefore, when the main power supply of the personal computer 2 is made to switch on, the power supply of the back up apparatus 1 also becomes ON at the same time.

The back up apparatus 1 comprises a back up switch and a restore switch. The back up switch is for selecting the operation of “data copy” from the hard disk drive apparatus 22 to the hard disk drive apparatus 4 for back up purpose; the restore switch is for selecting the operation of “data restoring” which is from the hard disk drive apparatus 4 for back up purpose to the hard disk drive apparatus 22. Back up copy or restoring copy, operation is selected by making the power supply of the personal computer 2 ON while pressing one of the switches.

Further, to the central processing unit 351, a display portion is also connected. The display portion comprises an operation condition that shows how the copying process is proceeding and an ending condition that shows the fact that copying operation has been finished. These displays arc constituted of, for instance, a crystal liquid image surface or light emitting diodes. Further, to the central processing unit 351, a switching operation means 354 is connected. The central processing unit 351 controls the switching means 34 between the two states, i.e. the communicable state and the copiable state, in accordance with the condition of the switching operation means 354. As described later, the switching operation means 354 comprises a back up switch 11 and a restore switch 12; when either one of the back up switch 11 or the restore switch 12 is made ON, the switching means 34 is kept in a copiable state and when both switches 11 and 12 are made OFF, the switching means 34 is kept in a communicable state.

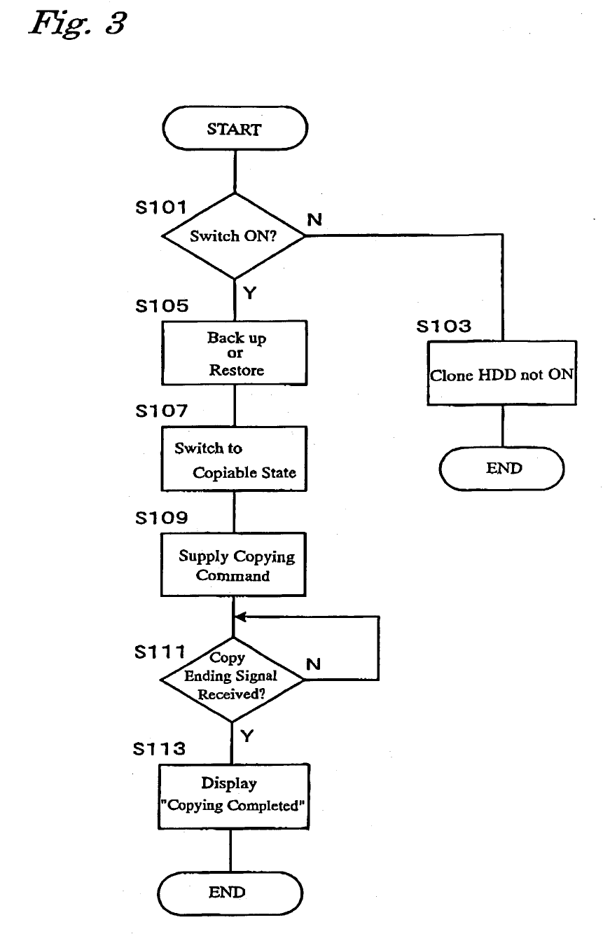

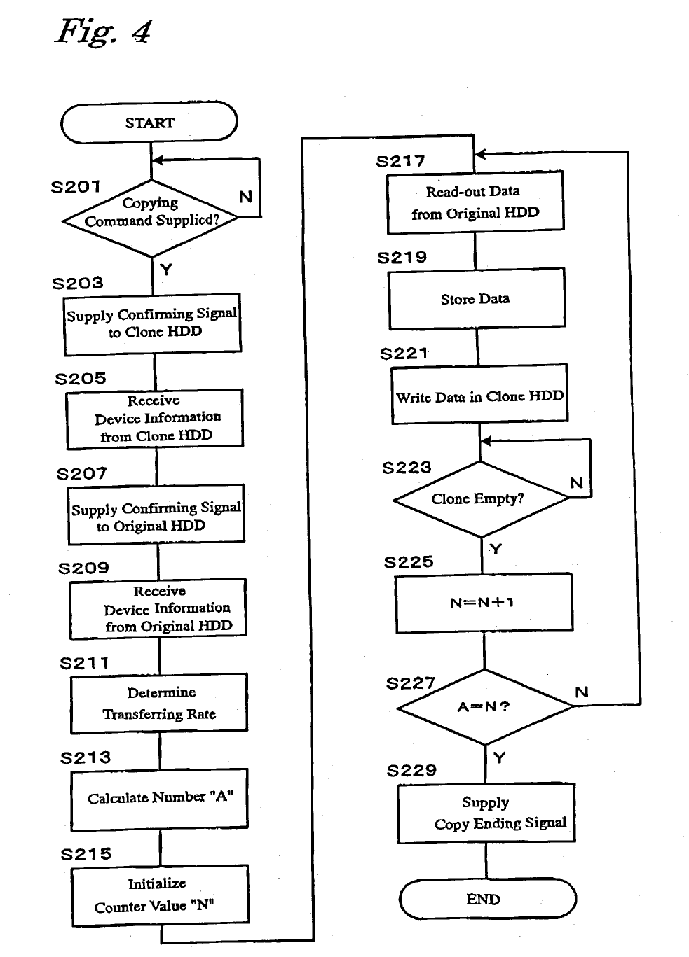

The operation of the controlling portion 3 of the back up apparatus 1 of the present invention will be explained, referring to the flow charts shown on FIGS. 3 and 4. In the following explanation, in order to make the terms easy to understand, the hard disk drive apparatus from which the data to be copied comes is called “original hard disk (original HDD)”, and the hard disk drive apparatus to which the data to be copied is sent is called “clone hard disk (clone HDD)”. Therefore, when the data is backed up, the hard disk drive apparatus 22 is an original hard disk and the hard disk drive apparatus 4 for back up purpose is a clone hard disk; while, when the data is restored, the hard disk drive apparatus 22 is a clone hard disk and the hard disk drive apparatus 4 for back up purpose is an original hard disk.

When the power supply of the personal computer 2 is made to be ON, the driving power source of, the back up apparatus 1 also becomes on; then the central processing means 351 starts to operate. The central processing unit 351 judges which one of the back up switch or the restore switch is being ON (Step S101). That is to say, the central processing unit 351 judges if the switching operation means 354 is switched in a position of the copiable state. In case that both switches are not ON, the driving power supply of the hard disk drive apparatus 4 is not made ON (Step S103), in this case the operation program is ended.

In a case that the back up switch or the restore switch is ON (the switching operation means 354 is in a position of the copiable condition), the hard disk drive apparatus 4 for back up purpose is made ON. Further, when the back up switch is ON, it is recognized so that the back up operation is conducted, while when the restore switch is ON, it is recognized so that the restoring operation is conducted. (Step S105) The case where the back up switch is ON will be explained below.

Then, a switching command signal is supplied to the switching means 34 (Step S107) to change the switching means 34 to the copiable condition. The signal from the motherboard 21 is not supplied to the hard disk drive apparatus 22 (original hard disk) thereby; the hard disk drive apparatus 22 and the hard disk drive apparatus 4 for back up purpose (clone hard disk) become communicable. The switching control operation is done by the operations from Step S101 to S107.

Next, a copying command signal is supplied to the secondary processing means 352 (Step S109). While the copying operation is being conducted in the secondary processing means 352, a connection-confirming signal is being sent from the motherboard 21 to the hard disk drive apparatus 22. However, since the communication circuit there between is shut off by the switching means 34, neither the connection confirming signal arrives to the hard disk drive apparatus 22 nor the response from the hard disk drive apparatus 22 arrives to the mother board 21. Therefore, the personal computer 2 is kept in a condition that the main power supply thereof is ON but the operating system does not work.

As will be stated below, when the copying operation is ending, a finishing signal is supplied from the secondary processing means 352, then the central processing means 351 judges if the copy finishing signal is received (Step S111). If the copy-finishing signal is not received the step S111 is repeated. When receiving the signal, the fact that the copying operation has been completed is mentioned on the display portion (Step S113). When making the power supply of the personal computer 2 off, the power supply of the back up apparatus 1 also is also made off, an then all operations arc ended.

Next, the operation of the secondary processing means 352 will be explained, referring to FIG. 4. The means 352 judges whether a copy command is supplied from the central processing unit 351 (Step S201). The copy command includes information about whether the copying operation should be backing up or storing. The means 352 sends a confirmation signal that is sent to the clone hard disk, and supplies a signal asking for information about the device, i.e. the capacity of the hard disk drive apparatus, the serial number, number of tracks, interface speed, etc. (Step S203) Then the means 352 receives a response signal from the clone hard disk about the information (Step S205). The means 352 sends the same signal to the original hard disk (Step S207) and receives the same information about the original hard disk (Step S209).

The secondary processing means 352 determines the data-transferring rate of each hard disk in accordance with the information received at the steps S205 and S209. According to the information received from the hard disks, the reading number “A”, which is necessary for reading out all data from the original hard disk, is counted (Step S213).

This number “A” can be obtained by dividing the whole capacity of the hard disk by the data amount of one read-out data operation. The data amount of the one reading data operation can be determined by the capacity of the memory 353 and the data transferring speed of the hard disk drive apparatus. The operation of reading the data from the original hard disk and writing the read-out data in the clone hard disk is counted as one count with the thus determined data amount of the one reading data operation as a unit data amount. The operation of copying the data in the whole area of the original hard disk to the clone hard disk is realized by conducting the read/write operation “A” times. Before starting the copying operation, the counter amount “N” should be initialized (Step S215).

Mirror copying is used for copying the data. That is to say, the data is read out from the recording medium of the original hard disk, using addresses that define the physical location on the recording medium of the hard disk drive apparatus, and writing them into the recording medium of the clone hard disk. The data is transferred on the basis of the transferring system of the interface; however, the type of the transferring system is not limited. For instance, IDE (Integrated Device Electronics) system, SCSI (Small Computer System Interface) system, or others may be similarly used.

During the mirror copying operation, the data is subsequently read out from the end of the recording medium in accordance with the physically defined address information. Therefore, the seeking time of the head of the hard disk drive apparatus can be shortened; thus the data reading out /writing in operation can be realized most effectively, so that the time for the copying operation can be shortened.

Then, a unit amount of data is read out from the original hard disk (Step S217). Address data showing the physical location where the data is recorded is added to the read out data, and then stored in the memory 353 (Step S219). The memory 353 is a dual port memory, which has two ports. The first port is used for inputting the read out data into the memory and the second port is used for outputting the stored data. The use of such dual port memory makes the data input/output operation into/from the memory easy and efficient, and the time for copying can be shortened. When the memory 353 is filled with data, the data reading operation is stopped; the data is taken from the memory 353 through the dual port to write it into the clone hard disk (Step 221). In the clone hard disk, the position where the data should be written is determined by the address data that has been added to the data.

Then, it is judged if the memory 353 becomes empty (Step S233). If the memory 353 is empty, one unit of data amount of the data copy has been completed; then the counter value “N” is incremented (Step S225) and it is judged whether the counter value “N” reaches the reading time “A”, which is necessary to read out all of the data (Step S227). In case that the counter value N does not reach to the reading time A, the steps S217 to S227 are repeated. When A=N is carried out, the data in the whole area of the original hard disk has been copied. Therefore, the copying operation should be completed, and a copying operation-finishing signal is sent to the central processing unit 351.

In order to restore the data, the hard disk drive apparatus 4 for back up purpose is used as the original hard disk, and the hard disk drive apparatus 22 is used as a the clone hard disk. The other operation is as the same as shown above.

In addition to the construction mentioned above, many modifications or alternatives may be considered. A data recording apparatus using other recording media may be used for the clone hard disk drive apparatus. For instance, an optical storage, such as an MO driving apparatus using an MO, a DVD driving apparatus using a DVD, may be preferably used. Further, any data recording apparatus may be used for the clone hard disk drive as far as the data recording apparatus has a sufficient capacity more than that of the original hard disk drive. Any data recording system may be used in the data-recording medium for the clone side, because the clone hard disk is not accessed from the central processing unit on the personal computer side. Therefore, a data recording system, which is not available to be read from the central processing unit, may be used as far as the data can be read out when the data is restored in the original hard disk. In the above-explained construction, an FIFO (First In First Out) memory can be preferably used for the memory 253. An FIFO memory is so designed that data can be taken out in the order that the data has been stored. Therefore, it is possible to take out data any time and thus a copying time can be shortened more.

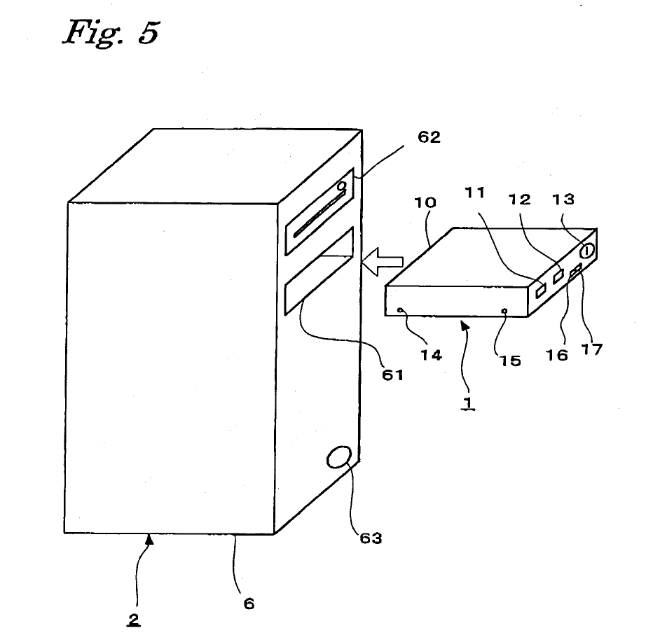

The apparatus having a construction mentioned above is held in the housing 10 in FIG. 5. The housing 10 comprises a back up switch 11 and a restore switch 12 on the front side thereof. Further, the housing comprises a keyhole on the front side, which is engaged with a key 13 for effecting the operation of the switches 11 and 12. Furthermore, the operation condition display portion 16 and the finishing sign display portion 17 are also provided on the front side.

Such a housing 10 is stored in a containing portion 61 provided in a case 6 of the personal computer 2. The containing portion 61 is for holding an optical storage, such as a CD-ROM drive. The housing 10 is so designed as to have the same size as the optical storage; the threaded holes 14 and 15 are provided On the side surface of the housing with the same standard as that for the optical storage. The apparatus 1 contained in the housing 10 is held in the containing portion 61 and fixed to the case 6 by means of threads that are engaged with the holes 14 and 15.

According to the construction above, the apparatus 1 is located beside the FDD drive 62; the front portion where operating switches are provided face an operator. Since the operating switches of the housing 10 are disposed on the front surface of the case 6, it becomes easier to conduct the back up operation or the restore operation; as a result, miss-operation is reduced.

For normal use, the system is locked with the key 13 to make the switches 11 and 12 disabled. Thus, trouble can be prevented such that the data is restored into the original hard disk drive apparatus by miss handling.

When backing up or restoring the data, the key 13 is unlocked; the rain power supply switch 63 of the personal computer is made to be ON while making either the back up switch 11 or the restore switch 12 ON. The power supply switch of the back up apparatus of the present invention is connected to the main power supply circuit of the personal computer 2 the power is obtained from the personal computer 2. The operations mentioned in the flow chart in FIG. 3 are started when the power is made ON.

As the switching means 34, such a circuit can be used that makes the motherboard 21 (central processing unit) and clone hard disk 4 communicable and interrupt the communication between the motherboard 21 and the original hard disk 22. In this case, it may be possible to design such that the mother board 21 can directly access to the clone hard disk 4, initiating the system using a software recorded in the clone hard disk 4 (that is to say, using the backed-up data).

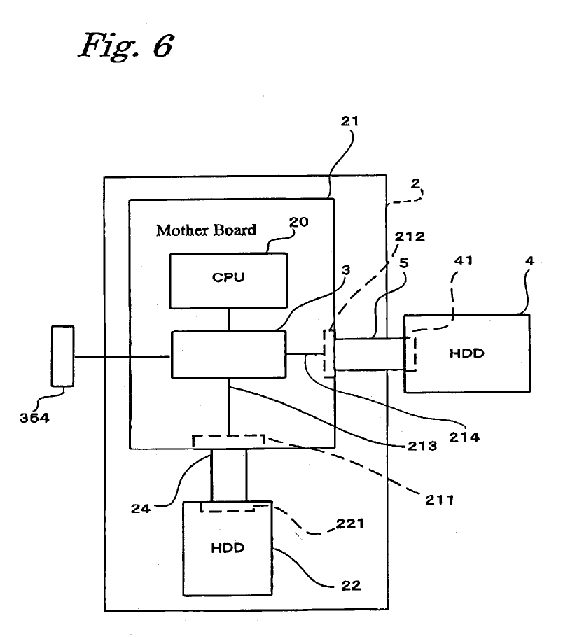

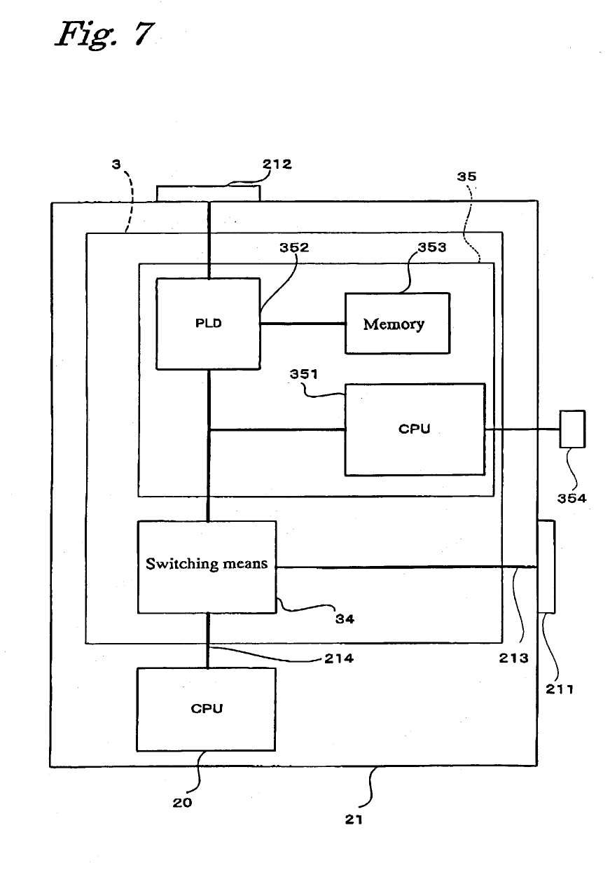

Next, a second embodiment of the back up apparatus according to the invention will be explained, referring to FIGS. 6 and 7. FIG. 6 is a block diagram showing the construction that the controlling portion 3 of the back up apparatus is provided on the mother board 21; and FIG. 7 is a block diagram depicting the detailed construction of the mother board 21.

On the motherboard 21, a CPU 20 is provided as a central processing unit; the controlling portion 3 is provided in an internal BUS 213, which connects the CPU 20 and the second memory, i.e. the hard disk drive apparatus 22. That is to say, the CPU 20 and the hard disk drive apparatus 22 are connected together via the controlling portion 3. The internal BUS 213 is connected to the input/output port 211, to which the hard disk drive apparatus 22 is connected. The controlling portion 3 is further connected to the input/output port 212 via an internal BUS 214; to the input/output port 212 the first memory, i.e. the hard disk drive apparatus 4, is connected.

As shown in FIG. 7, the internal BUS's 213 and 214 are directly connected to the switching means 34 in the controlling portion 3. Since the other structure is the same as that of the first embodiment in FIGS. 1 and 2, which has been already explained above, the explanation therefore is omitted here. According to the second embodiment, a motherboard having a backing up function can be realized, so that a space for the backing up apparatus can be saved.

In the construction of the second embodiment, the switching means 34 may be operated to switch the state by a basic software, which works in the CPU 20 of the motherboard 21, instead of the switching operation means 354. For instance, the software, called “BIOS” (Basic Input/Output System) can be preferably used for the basic software. In this case, it may be possible to constitute such that an operator instructs the switching operation from the image surface of the personal computer when the computer is started.

According to the invention mentioned in claim 1, the first memory is always in a condition that a communication to the central processing apparatus is not available; therefore, it is possible to completely keep the data stored in the first memory away from computer viruses.

According to the invention mentioned in claim 2, the switching means keeps the first memory always in a non-communicable state from the central processing unit. Therefore, the data in the first memory can be completely isolated from computer viruses. Further, the first memory to be connected to the first, connecting portion is exchangeable. Therefore, it is possible to exchange the first memory so as to have a capacity that is suitable for the capacity of the second memory.

According to the invention mentioned in claim 3, a semiconductor switch is used for the switching means. Therefore, in addition to the effect of the invention mentioned in claims 1 and 2, the delay time between the signal input timing into the switching means and the thus inputted signal output timing from the switching means becomes shorter, so that the back up apparatus of the invention can be connected to a system where a higher data transfer is carried out, without giving an influence to the data communication between the central processing apparatus and the second memory.

According to the invention mentioned in claim 4, in addition to the above-mentioned effect of the invention, when the data is backed up in a hard disk drive apparatus having a fast accessing speed, the time for backing up operation or restore operation can be shortened. Further, the back up system of the invention has a comparatively large memory capacity but the size is compact, so that it can be used for backing up the data stored in a large memory, but the apparatus as a whole can be kept to be compact.

According to the invention mentioned in claim 5, in addition to the above-mentioned effect of the invention, when the data stored in a hard disk drive apparatus is backed up, even if the data amount to be backed up is large, it is possible to finish the backing up operation or the restoring operation in a short time.

According to the invention mentioned in claim 6, since the switching control of the switching means is done by selecting the position of the switching operation means, which can be operated from outside. Therefore, the back up data can be isolated from the central processing unit more certainly, so that the data can be completely protected from computer viruses.

According to the invention mentioned in claim 7, the system is contained in a housing and the housing can be held in a case where the central processing apparatus is stored. Therefore, there is no need to keep a space especially for the system.

What is claimed is:

1. A data back up system comprising:
a switching means being connected to a first memory, a second memory, and a central processing unit for controlling said second memory, for switching a state of the data back up system between a communicable state that a communication between said first memory and said second memory is disabled keeping a condition in that a communication between said central processing unit and said first memory is disabled, but said central processing unit and said second memory can communicate together, and a copiable condition that a communication between said central processing unit and said second memory is disable but said first memory and said second memory can communicate together;
a switching operation control means for controlling said switching means between said communicable state and said copiable state; and
a copying operation control means for controlling a copying operation from said second memory to said first memory or from said first memory to said second memory under said copiable state.

2. A data back up system comprising;
a switching means having a first connecting portion for being connected to a first memory, a second connecting portion for being connected to a second memory, and a third connecting portion for being connected to a central processing unit, for switching a state of the data back up system between a communicable state that a communication between said first memory and said second memory is disabled keeping a condition in that a communication between said central processing unit and said first memory is disabled, but said central processing unit and said second memory can communicate together, and a copiable condition that a communication between said central processing unit and said second memory is disable but said first memory and said second memory can communicate together under a condition that said first memory, said second memory, and said central processing unit are connected together,
a switching operation control means for controlling said switching means between said communicable state and said copiable state; and
a copying operation control means for controlling a copying operation from said second memory to said first memory or from said first memory to said second memory under said copiable state.

3. A data back up system according to claim 1, wherein said switching means is a semiconductor switch.

4. A data back up system according to claim 1, wherein said first memory is a hard disk drive.

5. A data back up system according to claim 1, wherein said second memory is a hard disk drive.

6. A data back up system according to claim 1 further comprising a switching operation selecting means for selecting whether a copying operation of data to be recorded is conducted or not; and wherein said switching operation control means controls the switching means in accordance with the selection conducted in said switching operation selecting means.

7. A data back up state according to claim 1 further comprising a housing for containing said data back up system itself, wherein said housing comprises a fixing portion for detachably fixing the housing itself to a case in which said central processing unit is contained.
